(19) United States
(12) Patent Application Publication
(10) Pub. No.: US 2023/0385298 A1
(43) Pub. Date: Nov. 30, 2023

(54) METHOD AND APPARATUS OF EXTRACTING, STORING, AND QUERYING STRUCTURED DATA FROM DOCUMENTS AND IMAGES USING COMPUTER VISION

(71) Applicant: Hank AI, Inc., Lexington, SC (US)

(72) Inventors: Sergey A. Razin, Columbia, SC (US); Jack Neil, Lexington, SC (US); Samuel Hartzog, Saint George, SC (US); Stéphane Charette, West Kelowna (CA)

(73) Assignee: Hank AI, Inc., Lexington, SC (US)

(21) Appl. No.: 18/203,096

(22) Filed: May 30, 2023

Related U.S. Application Data
(60) Provisional application No. 63/346,944, filed on May 30, 2022.

(51) Int. Cl. G06F 16/25; G06F 16/93; G06V 30/416; G06V 30/14

(52) U.S. Cl. CPC G06F 16/254; G06F 16/256; G06V 30/1444; G06V 30/416; G06F 16/93

(57) ABSTRACT

Embodiments of the innovation relate to a data extraction device, comprising a controller having a processor and memory. The controller is configured receive an unstructured data file comprising a set of documents; apply the unstructured data file to a document identification model to identify a data element identifier and an associated data element of each document of the set of documents; apply an optical character recognition engine to the identified data element identifier and associated identified data element to generate a structured data element identifier and an associated structured data element, the structured data element identifier and the associated structured data element configured as machine-identifiable characters; embed the structured data element identifier and associated structured data element as metadata with the unstructured data file; and store the unstructured data file and metadata in a database.

### RELATED APPLICATIONS

This patent application claims the benefit of U.S. Provisional Application No. 63/346,944, filed on May 30, 2022, entitled, “Method and Apparatus of Extracting, Storing and Querying Structured Data from Documents and Images Using Computer Vision,” the contents and teachings of which are hereby incorporated by reference in their entirety.

### BACKGROUND

In certain industries, an enterprise can maintain written, physical file records for a given subject. For example, in the healthcare industry, a hospital can maintain a physical medical history record for each patient while in the energy industry, a utility company can maintain a file of physical invoices from its vendors.

To reduce the amount of paper required by physical files, many enterprises scan these physical file records into electronic format and utilize optical character recognition (OCR) to extract information from the documents. For example, an enterprise can utilize an OCR-based system to identify the presence of text, such as name and account number, at particular locations on a document.

### SUMMARY

Conventional text identification systems can suffer from a variety of deficiencies. For example, as provided above, enterprises can use an OCR-based systems to extract information from scanned, physical files. However, these system are unable to scale for large quantities of documents associated with a particular file. For example, with respect to vendor invoices, an enterprise such as a utility company may have a vendor invoice file that includes thousands of vendors, with each vendor having its own invoice format. While conventional OCR-based systems can identify particular text associated with such formats, conventional OCR-based systems are typically unable to identify the context associated with the text. In order to identify context, the document must be manually keyed in by hand, which can be time consuming and error prone.

By contrast to conventional text identification systems, embodiments of the present innovation relate to a method and apparatus of extracting, storing, and querying structured data from documents and images using computer vision. In one arrangement, a metadata extraction system is configured to extract structured data from documents contained within an unstructured electronic data file. The metadata extraction system can include a data extraction device having a data extraction engine configured to execute a document identification model. The document identification model is trained to determine both the type of document included with the data file, as well as the source of the document. With the document type and source known, the document identification model can identify the locations of data element identifiers (e.g., labels or tags) and associated data elements (e.g., the data corresponding to the tags, such as name, address, etc.) associated within each identified document and can generate a model output. The data extraction engine can pass the model output to an OCR engine to convert the data element identifiers and associated data elements to machine-readable structured data elements.

In one arrangement, the data extraction device includes a normalized transformation model configured to unify the data element identifier labels extracted from all documents contained within the unstructured electronic data file. Additionally, the data extraction device can be configured to embed the extracted structured the data element identifiers and associated data elements within the unstructured electronic data file as metadata. This allows for extracted structured data to be stored alongside with the original data file, such as a PDF or image file, without corrupting the original data file but allowing for the structured data to be extracted, or queried. In one arrangement, the document identification model can be configured as a federated hierarchical document identification model which is configured as a group of individual document identification models. This group, collectively, is configured to identify all of the types of documents contained within the unstructured data file.

Embodiments of the innovation relate to a data extraction device, comprising a controller having a processor and memory. The controller is configured receive an unstructured data file comprising a set of documents; apply the unstructured data file to a document identification model to identify a data element identifier and an associated data element of each document of the set of documents; apply an optical character recognition engine to the identified data element identifier and associated identified data element to generate a structured data element identifier and an associated structured data element, the structured data element identifier and the associated structured data element configured as machine-identifiable characters; embed the structured data element identifier and associated structured data element as metadata with the unstructured data file; and store the unstructured data file and metadata in a database.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a schematic representation of a metadata extraction system, according to one arrangement.

FIG. 2 illustrates a schematic representation of an unstructured data file, according to one arrangement.

FIG. 3 illustrates a schematic representation of a model output of a document identification model, according to one arrangement.

FIG. 4 illustrates a schematic representation of a data extraction device having a federated hierarchical document identification model, according to one arrangement.

### DETAILED DESCRIPTION

Embodiments of the present innovation relate to a method and apparatus of extracting, storing, and querying structured data from documents and images using computer vision. In one arrangement, a metadata extraction system is configured to extract structured data from documents contained within an unstructured electronic data file. The metadata extraction system can include a data extraction device having a data extraction engine configured to execute a document identification model. The document identification model is trained to determine both the type of document included with the data file, as well as the source of the document. With the document type and source known, the document identification model can identify the locations of data element identifiers (e.g., labels or tags) and associated data elements (e.g., the data corresponding to the tags, such as name, address, etc.) associated within each identified document and can generate a model output. The data extraction engine can pass the model output to an OCR engine to convert the data element identifiers and associated data elements to machine-readable structured data elements.

In one arrangement, the data extraction device includes a normalized transformation model configured to unify the data element identifier labels extracted from all documents contained within the unstructured electronic data file. Additionally, the data extraction device can be configured to embed the extracted structured the data element identifiers and associated data elements within the unstructured electronic data file as metadata. This allows for extracted structured data to be stored alongside with the original data file, such as a PDF or image file, without corrupting the original data file but allowing for the structured data to be extracted, or queried. In one arrangement, the document identification model can be configured as a federated hierarchical document identification model which is configured as a group of individual document identification models. This group, collectively, is configured to identify all of the types of documents contained within the unstructured data file.

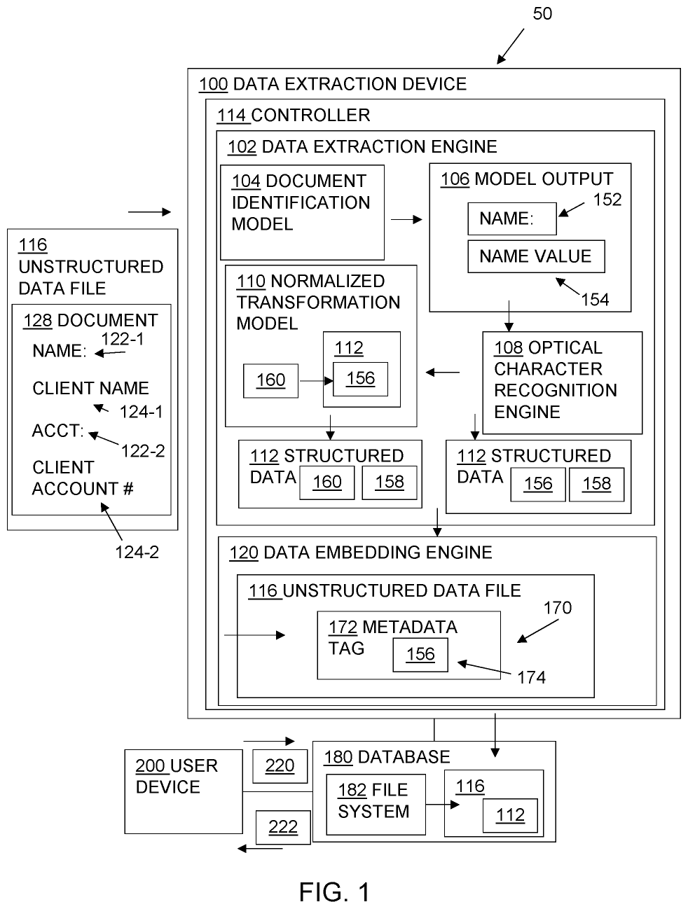

FIG. 1 illustrates a metadata extraction system 50, according to one arrangement. As illustrated, the metadata extraction system 50 can include a data extraction device 100 disposed in electrical communication with a database 180 via a network, such as a local area network (LAN) or a wide area network (WAN) for example. The data extraction device 100 is configured to extract structured data 112 from an electronic unstructured data file 116 and to embed the extracted, structured data 112 as metadata with a copy of the electronic unstructured data file 116. The data extraction device 100 can be configured as a computerized device having a controller 114, such as a processor disposed in electrical communication with a memory.

In one arrangement, the controller 114 can be configured to execute a data extraction engine 102 to perform a structured data extraction process on an unstructured data file 116. The unstructured data file 116 can be configured as an electronic file, such as a PDF file, which has a format that is typically readable by a human but that exists as an unrecognized data structure (e.g., not organized into a particular schema) and can include a plurality of documents 128. While the documents 128 included with the unstructured data file 116 can be configured as text-only, in one arrangement, one or more documents 128 can include image data or can be configured as image-only documents.

Each of the documents 128 can include data element identifiers 122 (e.g., labels or tags) and associated data elements 124 (e.g., the data corresponding to the tags) arranged on the document 128 in a unique manner. For example, as illustrated, the document 128 can include data element identifiers 122 such as the label “NAME:” 122-1 to identify a client's name and the label “ACCT:” 122-2 to identify the client's account number with an enterprise. Further, the document 128 can include data elements 124 such as “CLIENT NAME” 124-1 which is the name of the client and which corresponds to the “NAME:” 122-1 label and “CLIENT ACCOUNT #” 124-2 which is the account number of the client and which corresponds to the “ACCT:” 122-2 label.

In order to extract structured data from the various documents 128 contained within the unstructured data file 116, the data extraction engine 102 can apply the unstructured data file 116 received by the data extraction device 100 to a document identification model 104.

To generate the document identification model 104 for a given industry, in one arrangement, the data extraction device 100 can train a generic model with a variety of types of documents from that industry originating from a variety of sources. For example, the data extraction device 100 can train a generic identification model with a variety of unique vendor invoices in the energy industry to generate the document identification model 104 specific to vendor invoices received by energy providers.

During operation, the data extraction device 100 is configured to execute the document identification model 104 identify and locate various data element identifiers 122 and associated data elements 124 associated within each document 128 of the unstructured data file 116 for further processing.

In one arrangement and with reference to FIG. 1, during operation, the data extraction device 100 receives an unstructured data file 116 which includes a set of documents 128. For example, a user can electronically transmit or upload the unstructured data file 116 to the data extraction device 100 for further processing.

In response to receiving the unstructured data file, the data extraction engine 102 of the data extraction device 100 can apply the unstructured data file 116 to the document identification model 104 to identify a data element identifier 122 and an associated data element 124 of each document 128 of the set of documents. With application of the unstructured data file 116 to the document identification model 104, the document identification model 104 can locate the data element identifier 122 and the associated data element 124 on a document based upon identifying identify both a document source and a document type for each document 128 of the set of documents.

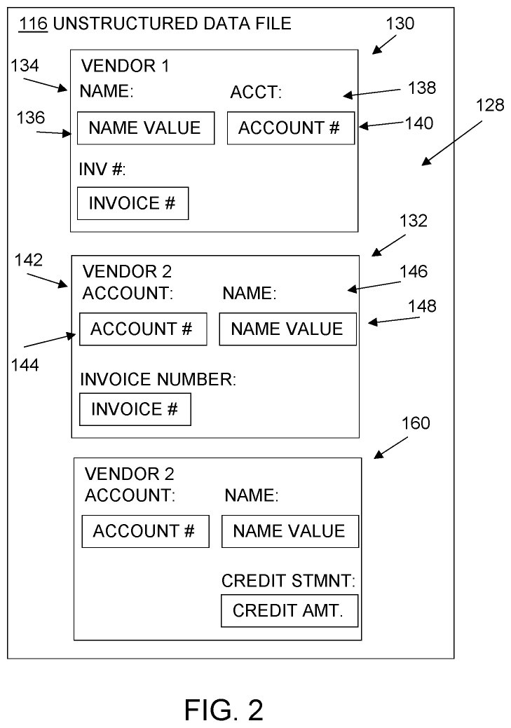

In one arrangement, with reference to FIG. 2, the unstructured data file 116 can include documents 128 originating from a variety of document sources. For example, the unstructured data file 116 can include a first document 130 originating from a first vendor, Vendor 1, and a second and third documents 132 originating from a second vendor, Vendor 2. As each document 130, 132 originates from unique document sources, each document 130, 132 can have a unique format or layout for the data element identifiers 122 and the associated data elements 124 specific to each particular vendor.

In one arrangement, the unstructured data file 116 can include documents 128 having a variety of document types. For example, the unstructured data file 116 can include a second document 130, an invoice, originating from a second vendor, Vendor 2, and a third document 160, a credit statement, originating from the second vendor, Vendor 2. As each document 130, 160 is configured as a different document type, each document 130, 160 can have a unique format or layout for the data element identifiers 122 and the associated data elements 124.

With application of the unstructured data file 116 to the document identification model 104, the document identification model 104 can identify both a type of document 128 included with the data file 116 (e.g., a vendor invoice, vendor credit statement) as well as the source of the document 128 (e.g., which particular vendor originated the invoice or credit statement). With the document type and source known, the document identification model 104 can, in turn, identify the locations of data element identifiers 122 and associated data elements 124 associated within each identified document 128.

In one arrangement, as indicated in FIG. 2, by identifying the first document 130 as originating from Vendor 1 and being configured as an invoice, based upon the training, the document identification model 104 can identify the location of the recipient name identifier 134, such as the tag “NAME:” and the location of the associated data element 136, such as the recipient name “NAME VALUE” in a first position, such as in an upper left-hand corner of the document 130. Further, the document identification model 104 can identify the location of the account number identifier 138, such as the tag “ACCT:” and the account number 140, such as the value “ACCOUNT #” in a second position, such as in the upper right-hand corner on the document 130.

With reference to the second document 132, by identifying the second document 132 as originating from Vendor 2 and being configured as credit statement, based upon the training, the document identification model 104 can identify the location of an account number identifier 142 “ACCOUNT:” and account number 144 “ACCOUNT #” located in a first position, such as in an upper left-hand corner of the document 132. Further, the document identification model 104 can identify the location of the recipient name identifier 146, such as the tag “NAME:” and the location of the associated data element 148, such as the recipient name “NAME VALUE” in a second position, such as in an upper right-hand corner of the document 132.

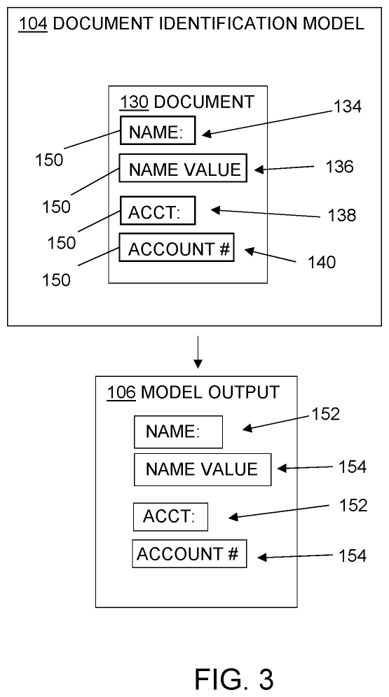

Following identification of the location of the data element identifiers 134, 138, 142, 146 and associated data elements 136, 140, 144, 148 of documents 130, 132, the document identification model 104 is configured to generate a bounding box 150 around each of the identified data element identifiers 134, 138, 142, 146 and associated identified data elements 136, 140, 144, 148. In one arrangement, during operation and with reference to the first document 130 in FIG. 3, the document identification model 104 is configured to conform or snap the boundaries of a rectangular-shaped bounding box 150 around each of the data element identifiers 134, 138 “NAME:” and “ACCT:” and around each of the associated data elements 136, 140 “NAME VALUE” and “ACCOUNT #”. During the bounding process, the document identification model 104 is configured to contain the unstructured text or image provided at the data element identifier 134, 138 and data element 136, 140 locations on the documents 130 to obtain accurate textual information associated with the locations.

After defining the boundaries 150 around each of the associated data elements 136, 140, the document identification model 104 incorporates the corresponding bounded data element identifiers 152 and associated bounded data elements 154 as part of a document identification model output 106. Each of the bounded data element identifiers 152 is configured to provide context to the bounded data elements 154 included in the document identification model output 106. Further, with reference to FIG. 1, the document identification model 104 is configured to provide the document identification model output 106 to an optical character recognition (OCR) engine 108.

With application of the OCR engine 108 to the bounded data element identifiers 152 and associated bounded data elements 154, the data extraction device 100 can generate structured data 112 having a structured data element identifier 156 and an associated structured data element 158. In one arrangement, the OCR engine 108 is configured to convert the unstructured images or characters of the bounded data element identifiers 152 and associated bounded data elements 154 of the document identification model output 106 into structured or machine-identifiable characters. For example, during operation, the OCR engine 108 can scan each bounded element 154 and bounded element identifier 152 contained within the document identification model output 106 and can convert the bounded elements and identifiers 154, 152 into corresponding structured data elements 158 and structured data element identifiers 156. Following the conversion, the OCR engine 108 can output structured data 112 having structured data element identifiers 156 and structured data elements 158. While the structured data 112 can be configured in a variety of formats, in one arrangement the structured data 112 is configured in a JavaScript Object Notation (JSON) format.

In one arrangement, the OCR engine 108 can provide the structured data 112 to a normalized transformation model 110 to replace the structured data element identifiers 156 with a normalized structured data element identifier.

Entities in a given industry may use different data element identifiers to reference the same concept in a document 128. For example, with reference to FIG. 2, Vendor 1 has labeled an account number with the identifier “ACCT:” on the first document 130 while Vendor 2 has labeled an account number with the identifier “ACCOUNT” on the second document 132. While not shown, other vendors can utilize a variety of labels for the concept of an account number, such as “ACCOUNT NUMBER,” “ACCT #′,” and “ACCT NO.”

As indicated in FIG. 1, in order to unify the various types of data element identifiers 156 which identify the same concept, the data extraction engine 102 applies the normalized transformation model 110 to the structured data element identifiers 156 received from the OCR engine 108. The normalized transformation model 110 has been trained to recognize information or data element identifiers on the documents 128 that relate to a common concept but that are labeled differently.

During operation, upon identifying each data element identifier 156 included with the structured data 112, the normalized transformation model 110 replaces the structured data element identifier 156 with a normalized structured data element identifier 160. For example, following identification of the data element identifier 156 as “ACCT:”, the normalized transformation model 110 can replace the identifier 156 “ACCT:” with the normalized or pre-defined data element identifier 160 “ACCOUNT NUMBER”. Following replacement of the data element identifier 156 with the normalized structured data element identifier 160, the normalized transformation model 110 can output structured data 112 which includes both normalized structured data element identifiers 160 and associated structured data elements 158.

With such replacement, the normalized transformation model 110 unifies the data element identifier labels contained on all documents 128 provided within an unstructured data file 116 for an end user. As such, the normalized data element identifiers 160 for all of the documents 128 can be readily indexed and searched within a database 180. Following generation of the structured data 112, which includes the structured data element identifier 156 and the associated structured data element 158, the data extraction device 100 can be configured to embed the structured data element identifier 156 and associated structured data element 158 as metadata with the unstructured data file 116. For example, with reference to FIG. 1, the data extraction device 100 can include a data embedding engine 120 configured to combine or store the structured data 112 extracted by the data extraction engine 102 with the original unstructured data file 116 while retaining the file type or format integrity of the unstructured data file 116.

The data embedding engine 120 can be configured to provide such a combination in a variety of ways. In one arrangement, the data embedding engine 120 can be configured to embed the structured data 112 as metadata 170 within the unstructured data file 116. For example, the data embedding engine 120 can create metadata tags 172 within the unstructured data file 116 based upon the structured data element identifiers 156 or the normalized structured data element identifiers 160 associated with the structured data 112. The data embedding engine 120 can then embed the corresponding structured data elements 158 or the normalized structured data element identifiers 160 as metadata elements 174 with each associated metadata tag 172. For example, the structured data elements 158 can be embedded with the data file 116 in JSON format.

In certain cases, the unstructured data file 116 may have a limit to the amount of metadata 170 that can be embedded. For example, the JPEG file format has 64 kilobyte limit to the amount of metadata that can be embedded in a JPEG file. In one arrangement, to mitigate metadata file limits associated with particular file formats, the data embedding engine 120 can be configured to append the unstructured data file 116 with the structured data 112. For example, the data embedding engine 120 can review the unstructured data file 116 for an end of file element associated with the file 116 and can append the unstructured data file 116 with the structured data 112 after the end of file message. In such a case, the unstructured data file 116 can include metadata 170 which is larger than the limit of the file format.

Following the embedding of the structured data 112 within the unstructured data file 116 as metadata 170, the data extraction device 100 can store the unstructured data file 116 with the associated metadata 170 as part of a database 180. In one arrangement, the database 180 is configured to allow for retrieval of the unstructured data file 116 as well as to allow for querying of the structured data 112. For example, the database 180 can be configured with a file system 182 that allows a user device 200 to search for unstructured data files 116, such as PDF documents, within the database 180. The file system 182 can also allow the user device 200 to search for metadata tags 172 associated with the unstructured data files 116, such as the structured data element identifiers 156 or the normalized structured data element identifiers 160 and the corresponding structured data elements 158 embedded with the data files 116. With such a configuration, the database 180 can receive a query 220, such as metadata tags, from a user within the enterprise and can searching on extracted metadata 170, based on the query 220 with a relatively high level of detail. Further, the database 180 can provide a response 222 to the query 220, such as one or more documents 128 associated with one or more unstructured data files 116, based upon a correspondence between the queried metadata tags 220 and the structured data metadata 170 stored within the unstructured data files 116.

Accordingly, the metadata extraction system 50 allows an enterprise to extract information from a number of documents 128 in an unstructured data file 116 in an automated manner and to identify the context associated with the extracted data elements 124. As such, the metadata extraction system 50 mitigates the need for an enterprise to identify data element context by manually keying in the information of each document 128 of an unstructured data file 116 by hand, which can be time consuming and error prone. The metadata extraction system 50 speeds up the data extraction process and increases accuracy. Further, the metadata extraction system 50 allows an enterprise to embed extracted structured data element identifiers 156 and associated structured data elements 158 as metadata 170 with the unstructured data file 116 and to store the unstructured data file 116 as part of a database 180. This provides the enterprise with the ability to search the database 180 using metadata tags 172 with a relatively high level of detail and to retrieve unstructured data files 116 having the searched metadata tags 172 with a relatively high level of accuracy.

As provided above, the document identification model 104 can be generated through the training of a generic model with different documents from a particular industry. Based upon the training on particular documents within a particular industry, the document identification model 104 is configured to identify each type of document 128 contained within an unstructured data file 116 (e.g., invoice), as well as the source of the document 128 (e.g., particular vendor, supplier, etc.). In certain cases, however, the unstructured data file 116 can include different types of documents 128 which relate to a common subject. For example, the unstructured data file 116 can be configured as patient healthcare records which can include a face sheet and additional documents which provide information detailing various examinations or procedures which a patient has undergone. Each one of the documents 128 can have its own unique format. For example, the healthcare records can include a first document from the patient's primary care physician outlining the patient's physical examination and a second document from the patient's orthopedic surgeon detailing the patient's surgical procedure.

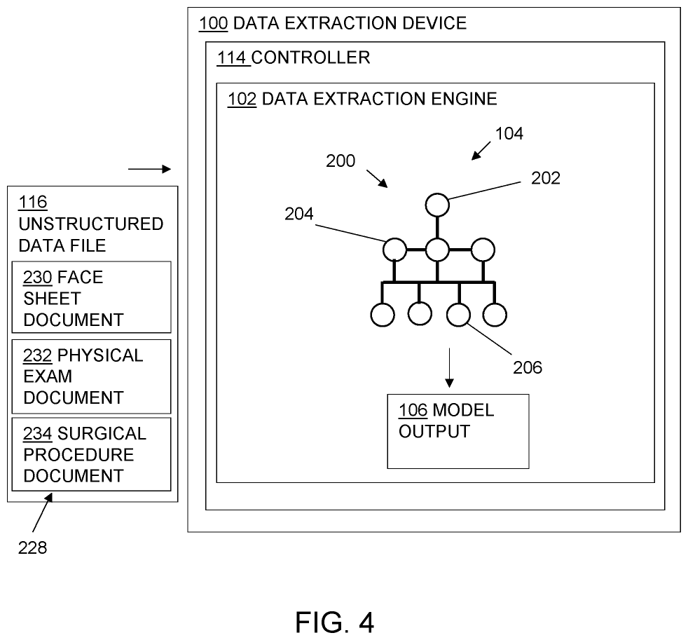

With reference to FIG. 4, in order to extract structured data 112 from the various types documents 128 contained within the unstructured data file 116, the document identification model 104 can configured as a federated hierarchical document identification model 200. As shown, the federated hierarchical document identification model 200 is configured as a group of individual document identification models which, collectively, are configured to identify all of the types of documents 128 contained within the unstructured data file 116. For example, each individual model within the federated hierarchical document identification model 200 can be trained to determine both the type of document 128 included with the data file (e.g., a face sheet, examination record, surgical record, etc.) as well as the source of the invoice (e.g., which particular hospital or department originated the document). With the document type and source known, the individual model of the federated hierarchical document identification model 200 can, in turn, identify the locations of data element identifiers 122 and associated data elements 124 associated within each identified document 128.

For example, in the case of patient healthcare records, the federated hierarchical document identification model 200 can include, as part of the hierarchy, a face sheet identification model 202, an examination record identification model 204, and a surgical record identification model 206. During operation, when the model 200 receives the unstructured data file 116, with the hierarchical structure, each document 128 in the file 116 can be passed to the appropriate model for analysis. For example, in response to receiving a face sheet document 230, the face sheet identification model 202 is configured to identify the document as a face sheet document 230 and generate a corresponding model output 106.

Further, in response to receiving a physical examination document 232, the face sheet identification model 202 can pass the document 232 to the next level of the federated hierarchical document identification model 200 for processing. With the examination record identification model 204 being present in the next hierarchical tier, the examination record identification model 204 is configured to identify the document as a physical examination document 232 and generate a corresponding model output 106.

Also in this example, in response to receiving a surgical procedure document 234, the face sheet identification model 202 can pass the document 234 to the second level of the federated hierarchical document identification model 200, which, in turn, can pass the document 234 to the third level of the federated hierarchical document identification model 200 for processing. With the surgical record identification model 206 being present in the next hierarchical tier, the surgical record identification model 206 is configured to identify the document as a surgical procedure document 234 and generate a corresponding model output 106.

While various embodiments of the innovation have been particularly shown and described, it will be understood by those skilled in the art that various changes in form and details may be made therein without departing from the spirit and scope of the innovation as defined by the appended claims.

What is claimed is:

1. A data extraction device, comprising:
a controller having a processor and memory, the controller configured to:
receive an unstructured data file comprising a set of documents;
apply the unstructured data file to a document identification model to identify a data element identifier and an associated data element of each document of the set of documents;
apply an optical character recognition engine to the identified data element identifier and associated identified data element to generate a structured data element identifier and an associated structured data element, the structured data element identifier and the associated structured data element configured as machine-identifiable characters;
embed the structured data element identifier and associated structured data element as metadata with the unstructured data file; and
store the unstructured data file and metadata in a database.

2. The data extraction device of claim 1, wherein when applying the unstructured data file to the document identification model to identify the data element identifier and the associated data element of each document of the set of documents, the controller is configured to:
identify a document type and a document source for each document of the set of documents; and
in response to identifying the document type and the document source for each document of the set of documents, identifying a location of the data element identifier and the associated data element of each document of the set of documents.

3. The data extraction device of claim 2, wherein the controller is configured to:
generate a bounding box around the data element identifier and associated data element of each document of the set of documents; and
provide a document identification model output to the optical character recognition engine, the document identification model output including the bounded data element identifier and associated bounded data element as the identified data element identifier and associated identified data element.

4. The data extraction device of claim 2, wherein when applying the optical character recognition engine to the identified data element identifier and associated identified data element to generate the structured data element identifier and the associated structured data element, the controller is configured to:
apply the optical character recognition engine to the bounded data element identifier and associated bounded data element to generate the structured data element identifier and the associated structured data element.

5. The data extraction device of claim 2, wherein the controller is configured to apply the structured data element identifier to a normalized transformation model to replace the structured data element identifier with a normalized structured data element identifier, the normalized structured data element identifier being unified for each document of the set of documents.

6. The data extraction device of claim 1, wherein when embedding the structured data element identifier and associated structured data element as metadata with the unstructured data file, the controller is configured to:
create metadata tags within the unstructured data file based upon the structured data element identifier; and
embed the corresponding structured data element as a metadata element with the associated metadata tag.

7. The data extraction device of claim 1, wherein the document identification model is configured as a federated hierarchical document identification model.

8. In a data extraction device, a method of extracting and storing structured data from an unstructured data file, comprising:
receiving an unstructured data file comprising a set of documents;
applying the unstructured data file to a document identification model to identify a data element identifier and an associated data element of each document of the set of documents;
applying an optical character recognition engine to the identified data element identifier and associated identified data element to generate a structured data element identifier and an associated structured data element, the structured data element identifier and the associated structured data element configured as machine-identifiable characters;
embedding the structured data element identifier and associated structured data element as metadata with the unstructured data file; and
storing the unstructured data file and metadata in a database.

9. The method of claim 8, wherein applying the unstructured data file to the document identification model to identify the data element identifier and the associated data element of each document of the set of documents comprising:
identifying a document type and a document source for each document of the set of documents; and
in response to identifying the document type and the document source for each document of the set of documents, identifying a location of the data element identifier and the associated data element of each document of the set of documents.

10. The method of claim 9, comprising:
generating a bounding box around the data element identifier and associated data element of each document of the set of documents; and
providing a document identification model output to the optical character recognition engine, the document identification model output including the bounded data element identifier and associated bounded data element as the identified data element identifier and associated identified data element.

11. The method of claim 9, wherein applying the optical character recognition engine to the identified data element identifier and associated identified data element to generate the structured data element identifier and the associated structured data element comprises:
applying the optical character recognition engine to the bounded data element identifier and associated bounded data element to generate the structured data element identifier and the associated structured data element.

12. The method of claim 9, comprising applying the structured data element identifier to a normalized transformation model to replace the structured data element identifier with a normalized structured data element identifier, the normalized structured data element identifier being unified for each document of the set of documents.

13. The method of claim 8, wherein embedding the structured data element identifier and associated structured data element as metadata with the unstructured data file comprises:
creating metadata tags within the unstructured data file based upon the structured data element identifier; and
embedding the corresponding structured data element as a metadata element with the associated metadata tag.

14. The method of claim 8, wherein the document identification model is configured as a federated hierarchical document identification model.

15. A metadata extraction system, comprising:
a database; and
a data extraction device disposed in electrical communication with the database, the data extraction device comprising:
a controller having a processor and memory, the controller configured to:
receive an unstructured data file comprising a set of documents,
apply the unstructured data file to a document identification model to identify a data element identifier and an associated data element of each document of the set of documents,
apply an optical character recognition engine to the identified data element identifier and associated identified data element to generate a structured data element identifier and an associated structured data element, the structured data element identifier and the associated structured data element configured as machine-identifiable characters,
embed the structured data element identifier and associated structured data element as metadata with the unstructured data file, and
store the unstructured data file and metadata in the database.
